(19) United States
(12) Patent Application Publication
(10) Pub. No.: US 2025/0083883 A1
(43) Pub. Date: Mar. 13, 2025

(54) POUCH AND CONTAINER ASSEMBLY FOR STORING A FLUID PRODUCT AND DEVICE FOR STORING AND DISPENSING THE FLUID PRODUCT

(71) Applicant: L'OREAL, Paris (FR)

(72) Inventors: JinSeok KIM, Shanghai (CN); Chunjie LI, Shanghai (CN); Yi SHI, Shanghai (CN); Emeric RENAUDIN, Shanghai (CN); Gonghao XUE, Shanghai (CN)

(73) Assignee: L'OREAL, Paris (FR)

(21) Appl. No.: 18/720,409

(22) PCT Filed: Dec. 1, 2022
(86) PCT No.: PCT/CN2022/136030

§ 371 Date: Jun. 14, 2024

(30) Foreign Application Priority Data
Dec. 25, 2021 (CN) 202123325199.X

(51) Int. Cl. B65D 75/58; A45D 34/00; A45D 40/00; B65D 77/06

(52) U.S. Cl. CPC B65D 75/5883; A45D 34/00; A45D 40/00; B65D 77/06; A45D 2034/005; B65D 2575/586

(57) ABSTRACT

The invention relates to a pouch for storing a fluid product, in particular cosmetic product, comprising: a sachet defining an inner volume in which the fluid product is contained; a spout attached to the sachet in a sealing manner and defining a channel leading into the inner volume of the sachet, the channel having an inlet end toward the inner volume of the sachet and an outlet end opposite the inlet end; a closure comprising a body having a first segment with a first radial dimension and a second segment with a second radial dimension larger than the first radial dimension, wherein the second segment is located on a side of the first segment toward the inner volume of the sachet; wherein the closure is configured to prevent air from entering the inner volume of the sachet through the channel in a sealing position, wherein the closure is at least partially disposed in the channel and engages the spout when arranged in the sealing position; and wherein the closure can be displaced away from the sealing position when pushed by a pushing member toward the inner volume of the sachet to unseal the pouch. The invention also relates to a container assembly comprising the pouch and a device for storing and dispensing at least one fluid product comprising the container assembly.

### FIELD OF INVENTION

The present invention generally relates to a pouch and a container assembly for storing a fluid product, for example in liquid or paste form, in particular a cosmetic product. The present invention also relates to a device for storing and dispensing the fluid product comprising the container assembly.

### BACKGROUND

Devices for storing and dispensing at least one fluid product, especially cosmetic product, have been developed. Typically, the device includes a container for holding the cosmetic product, and components for delivering the cosmetic product from the container and discharging the same.

For example, a dispenser for cosmetic products is known from U.S. Pat. No. 10,661,290B2. The dispenser comprises a dispensing head and two containers arranged in an outer shell of the dispenser. The dispensing head includes two mandrel shaped protrusions that can press the filling valves into an open position. CN214711061U discloses a bottle for cosmetic product with reusable dispensing components and a container. The dispensing components can be detached from the container for reuse.

Some products are easily deteriorated when put in contact with air. For example, some cosmetic products are prone to be oxidized with oxygen in the air, and/or are prone to be hydrolyzed with water or moisture in the air. Also, once exposed to the air, a product is prone to be contaminated by contaminants or debris that may be contained in the air.

Therefore, in some cases, it is important to avoid exposure of the cosmetic products from being exposed to air, for example, air retained in the container or from the environment before use.

Also, providing reusable components is advantageous since this makes it possible to provide a more environmental-friendly device and to lower the cost. A device for storing and dispensing at least one fluid product having an easily replaceable part is desired. In order to provide a good user experience, a replacement procedure should not require much effort.

Therefore, there is a need for an improved container, for example a pouch or a container assembly, that can be properly sealed until being put into use, can avoid exposure of cosmetic product(s) contained therein to the atmosphere even during installation of the container to dispensing components, and can include minimimal residual air in the container assembly before unsealing thereof.

There is also a need for an improved device for storing and dispensing at least one cosmetic product comprising the container, which allows particularly easy detachment of dispensing components from the container, as well as simple and reliable attachment of dispensing components to the container.

### SUMMARY

It is an object of the present invention to provide an improved pouch, an improved container assembly and an improved device for storing and dispensing at least one fluid product, in particular cosmetic product, which achieve at least the advantages as described above.

According to an aspect of the present invention, there is provided a pouch for storing a fluid product, in particular cosmetic product, comprising: a sachet defining an inner volume in which the fluid product is contained; a spout attached to the sachet in a sealing manner and defining a channel leading into the inner volume of the sachet, the channel having an inlet end toward the inner volume of the sachet and an outlet end opposite the inlet end; a closure comprising a body having a first segment with a first radial dimension and a second segment with a second radial dimension larger than the first radial dimension, wherein the second segment is located on a side of the first segment toward the inner volume of the sachet; wherein the closure is configured to prevent air from entering the inner volume of the sachet through the channel in a sealing position, wherein the closure is at least partially disposed in the channel and engages the spout when arranged in the sealing position; and wherein the closure can be displaced away from the sealing position when pushed by a pushing member toward the inner volume of the sachet to unseal the pouch.

In an embodiment, the closure is integrally formed with the spout, wherein the second segment preferably has a smaller longitudinal thickness than the first segment.

In an embodiment, the closure comprises a cap, wherein the cap is separated from the spout when displaced away from the sealing position, wherein the first segment of the body of the cap comprises a first cylindrical wall and a pressing plate, and wherein the second segment of the body of the cap comprises a second cylindrical wall having a larger outer diameter than the first cylindrical wall.

In an embodiment, the cap further comprises a holding bar extending from the pressing plate toward the inner volume of the sachet, the holding bar preferably having a cross-section that is cross-shaped.

In an embodiment, the body of the cap defines a cavity located toward the inner volume of the sachet.

In an embodiment, the body of the cap further comprises a tapered third segment between the first segment and the second segment, wherein the third segment has a supporting surface extending in a radial plane and a side surface having a conical shape.

In an embodiment, the second segment of the body of the cap is provided with raised portions, preferably annular raised portions, for abutting against the spout.

In an embodiment, the pouch further comprises a rod having a cross-shaped section, the rod extending from the spout into the inner volume of the sachet.

In an embodiment, the sachet is formed of two films joined to each other along their peripheries, wherein each of the films comprises a tail portion having a reduced width, wherein the tail portions of the two films are joined together to form a tail of the pouch, wherein the tail portions of the two films preferably have different lengths.

According to a further aspect of the present invention, there is provided a container assembly for storing at least one fluid product, in particular cosmetic product, comprising: an outer container, which is preferably made of paper, plastic, glass or metal, for example aluminum; at least one pouch according to the present invention that is disposed in the outer container; and a pouch holder for holding the pouch, the pouch holder being attached to the outer container.

According to a further aspect of the present invention, there is provided a device for storing and dispensing at least one fluid product, in particular cosmetic product, comprising: a container assembly according to the present invention; a dispensing assembly that can be attached to the container assembly and that can be detached from the container assembly; wherein the dispensing assembly comprises the pushing member, which pushes the closure such that the closure is displaced away from the sealing position when the dispensing assembly is moved toward the container assembly so as to be attached to the container assembly.

In an embodiment, the dispending assembly comprises an applicator, an airless pump and a collar that is provided with the pushing member, wherein the airless pump is arranged between the applicator and the collar, wherein the pushing member preferably comprises a tip having a cross-shaped section and tapered side surfaces.

In an embodiment, the dispensing assembly can be attached to the container assembly by connecting the collar to the spout of the pouch or to the pouch holder through a threaded connection or through an interference fit.

In an embodiment, the dispensing assembly is provided with a lock member, the lock member comprising a first end portion, a second end portion and a first middle portion between the first end portion and the second end portion, wherein the first middle portion comprises a first arm connected to the first end portion via a first hinge, a second arm connected to the second end portion via a second hinge, and a latch connected on one end to the first arm via a third hinge, and connected on the other end to the second arm via a fourth hinge, wherein the lock member can be moved between a locked position and an unlocked position; wherein the container assembly, preferably the pouch holder, is provided with a holding means; wherein in the locked position, the latch of the lock member is held by the holding means of the container assembly, such that the dispensing assembly is attached to the container assembly; and wherein in the unlocked position, the latch of the lock member is released from the holding means of the container assembly, such that the dispensing assembly is detached from the container assembly.

In an embodiment, the first end portion of the lock member comprises a first end plate, a first guiding bar and a first retaining bar, and the second end portion of the lock member comprises a second end plate, a second guiding bar and a second retaining bar; wherein the first guiding bar is connected to the first arm of the first middle portion via the first hinge, wherein the second guiding bar is connected to the second arm of the first middle portion via the second hinge; wherein the collar is provided with a first retaining means for retaining the first retaining bar, and a second retaining means for retaining the second retaining bar.

In an embodiment, an acute angle in the range of 25-75 degrees, preferably in the range of 30-60 degrees, preferably in the range of 35-45 degrees, in particular 39 degrees is defined between a longitudinal axis of the first arm and a longitudinal axis of the lock member, and between the longitudinal axis of the second arm and the longitudinal axis of the lock member.

In an embodiment, the first guiding bar is connected to the first retaining bar by an L-shaped supporting bar.

In an embodiment, the lock member further comprises a second middle portion between the first end portion and the second end portion, wherein the second middle portion comprises a first arm connected to the first end portion via a first hinge, a second arm connected to the second end portion via a second hinge, and a latch connected on one end to the first arm via a third hinge, and connected on the other end to the second arm via a fourth hinge; wherein preferably, the first arm of the second middle portion is connected to a third guiding bar of the first end portion of the lock member, and the second arm of the second middle portion is connected to a fourth guiding bar of the second end portion of the lock member.

The above and further aspects of the present disclosure will be more readily understood from the detailed description, the claims and the drawings. The detailed description and specific examples are intended for purposes of illustration only and are not intended to limit the scope of the disclosure.

### BRIEF DESCRIPTION OF THE DRAWINGS

Implementations of the present invention will now be described, by way of example only, with reference to the drawings, wherein:

FIG. 1A is a schematic perspective view of a first embodiment of the device for storing and dispensing at least one fluid product according to the present invention in an inactivated state before first use;

FIG. 1B is a schematic perspective view of a first embodiment of the device for storing and dispensing at least one fluid product according to the present invention in an activated state;

FIG. 1C is a schematic perspective view of a first embodiment of the device for storing and dispensing at least one fluid product according to the present invention, showing a dispensing assembly detached from a container assembly;

FIG. 1D is a schematic perspective view of a first embodiment of the device for storing and dispensing at least one fluid product in an activated state, with outer container removed;

FIG. 2 is a schematic partial enlarged sectional view of the first embodiment of the device in the activated state, taken in a medial plane thereof;

FIG. 3A is a schematic perspective view of a collar of the first embodiment of the device;

FIG. 3B is a further schematic perspective view of the collar of the first embodiment of the device;

FIG. 4 is a schematic perspective view of an applicator of the first embodiment of the device;

FIG. 5A is a schematic perspective view of a pouch of the first embodiment of the device;

FIG. 5B is a schematic sectional view of the pouch of the first embodiment of the device, taken in a medial plane thereof;

FIG. 6A is a schematic perspective view of a cap of the first embodiment of the device;

FIG. 6B is a further schematic perspective view of the cap of the first embodiment of the device;

FIG. 6C is a further schematic sectional view of the cap of the first embodiment of the device, taken in a medial plane thereof;

FIG. 7A is a schematic perspective view of a spout of the first embodiment of the device;

FIG. 7B is a further schematic perspective view of the spout of the first embodiment of the device;

FIG. 8 is a schematic partial enlarged sectional view of the upper section of the pouch of the first embodiment of the device, taken in a medial plane thereof;

FIG. 9 is a schematic perspective view of a rod of the first embodiment of the device;

FIG. 10A is a schematic perspective view of a pouch holder of the first embodiment of the device;

FIG. 10B is a further schematic perspective view of the pouch holder of the first embodiment of the device;

FIG. 11 is a schematic partial enlarged sectional view of the first embodiment of the device in an inactivated state, taken in a medial plane thereof;

FIG. 12A is a schematic perspective view of a lock member of the first embodiment of the device;

FIG. 12B is a further schematic perspective view of the lock member of the first embodiment of the device;

FIG. 12C is a schematic top plan view of the lock member of the first embodiment of the device;

FIG. 13 is a schematic perspective view showing the lock member arranged on the collar according to the first embodiment of the device;

FIG. 14 is a schematic perspective view showing the lock member arranged on the pouch holder according to the first embodiment of the device;

FIG. 15A is a schematic perspective view of a variant of the spout;

FIG. 15B is a schematic perspective view of the variant of the spout as shown in FIG. 15A;

FIG. 16 is a schematic sectional view of the variant of the spout as shown in FIG. 15A, taken in a medial plane thereof;

FIG. 17A is a schematic perspective view of a second embodiment of the device for storing and dispensing at least one fluid product according to the present invention in an activated state;

FIG. 17B is a schematic exploded view of the second embodiment of the device for storing and dispensing at least one fluid product according to the present invention;

FIG. 17C is a schematic drawing showing the replacement of a container assembly according to the second embodiment of device according to the present invention;

FIG. 18 is a schematic cut-away view of a pouch of the second embodiment of the device;

FIG. 19 is a schematic partial enlarged sectional view of the second embodiment of the device in an inactivated state, taken in a medial plane thereof;

FIG. 20 is a schematic partial enlarged sectional view of the second embodiment of the device in the activated state, taken in a medial plane thereof;

FIG. 21A is a schematic perspective view of a third embodiment of the device for storing and dispensing at least one fluid product according to the present invention in an activated state;

FIG. 21B is a schematic exploded view of the third embodiment of the device for storing and dispensing at least one fluid product according to the present invention;

FIG. 22 is a schematic perspective view of the pouch of the third embodiment of the device;

FIG. 23 is a schematic partial enlarged sectional view of the third embodiment of the device in an inactivated state, taken in a medial plane thereof;

FIG. 24 is a schematic partial enlarged sectional view of the third embodiment of the device in the activated state, taken in a medial plane thereof.

In the drawings, similar reference numerals may be used for denoting similar and/or identical elements. The drawings are not necessarily drawn to scale.

### DETAILED DESCRIPTION

The following description is merely exemplary in nature and is not intended to limit the present disclosure, application, or uses. Throughout the drawings, corresponding reference numerals indicate similar or corresponding parts and features. It should be understood that although wordings related to directions such as “top,” “bottom”, “above”, “below”, “back”, “lower”, “upper”, “left” and “right” are used with reference to the drawings or specific embodiments, these wordings are for illustrative purposes only and are not intended to require specific orientations unless otherwise stated. These directions are merely provided as a frame of reference with respect to the examples provided, but could be altered in alternate applications.

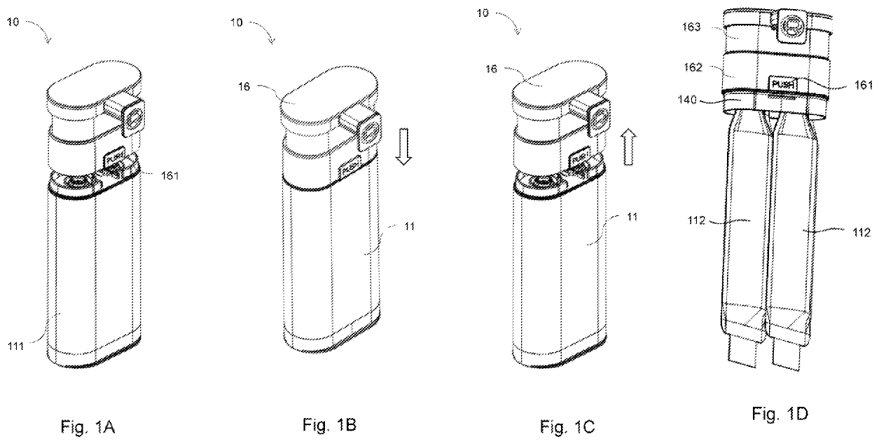

FIG. 1A is a schematic perspective view of a first embodiment of a device 10 for storing and dispensing at least one fluid product according to the present invention, in an inactivated state before first use. FIG. 1B shows the device 10 in a fully-assembled or activated state. As can be seen, the device 10 comprises a container assembly 11 and a dispensing assembly 16 that can be mounted onto the container assembly 11. In the inactivated state as shown in FIG. 1A, the dispensing assembly 16 has not yet been attached to the container assembly 11. In the activated state as shown in FIG. 1B, the dispensing assembly 16 is attached to the container assembly 11. As shown in FIG. 1C, the dispensing assembly 16 can also be detached from the container assembly 11 for reuse.

In order to attach the dispensing assembly 16 to the container assembly 11, the dispensing assembly 16 is brought to a position above the container assembly 11 and aligned therewith. The dispensing assembly 16 can then be attached to the container assembly 11 by moving the dispensing assembly 16 downwards into engagement with the container assembly 11.

In this embodiment, the container assembly 11 comprises an outer container 111, two pouches 112 for containing fluid products received in the outer container 111, and a pouch holder 140 disposed at one end of the outer container 111. FIG. 1D shows the device 10 with the outer container 111 removed, revealing the pouches 112 attached to the pouch holder 140, which is in turn attached to the dispensing assembly 16.

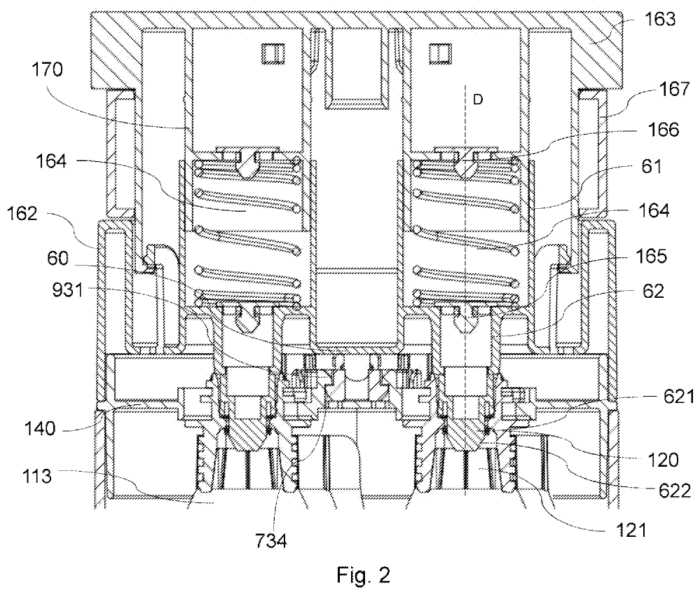

Each of the pouches 112 is pre-filled with a fluid product that is to be dispensed through a channel 121 defined by a spout 120 of the pouch 112 by means of an airless pump 164 of the dispensing assembly 16. The details of the airless pump 164 are not shown in Fig.2.

FIG. 2 is a partial enlarged cross-sectional view of the device 10 in the activated state. As shown in FIG. 1A and FIG. 2, the dispensing assembly 16 comprises a collar 162, a lock member 161 attached to the bottom of the collar 162, an applicator 163, two airless pumps 164 supported on the collar 162, inlet and outlet valves 165, 166 and an anti-press spacer 167.

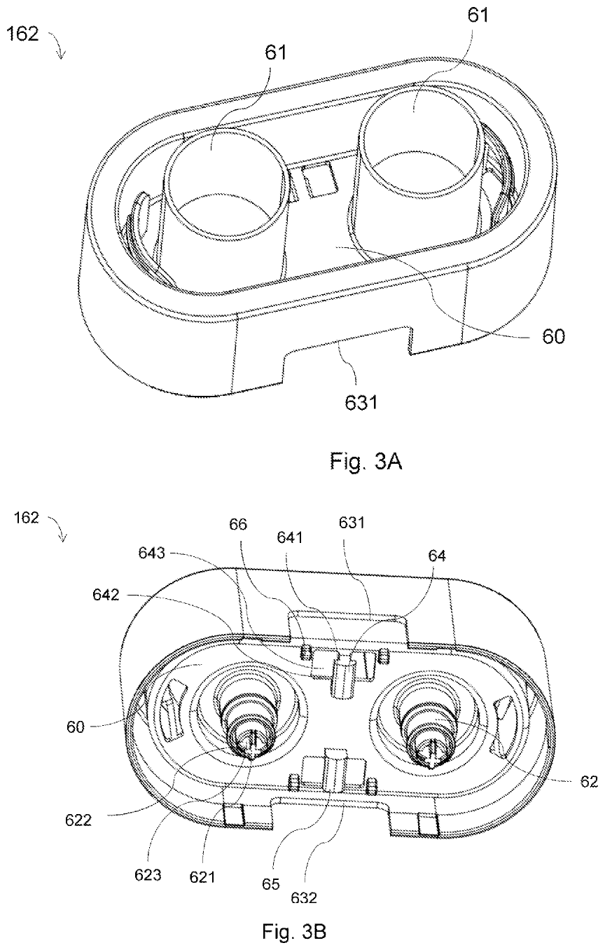

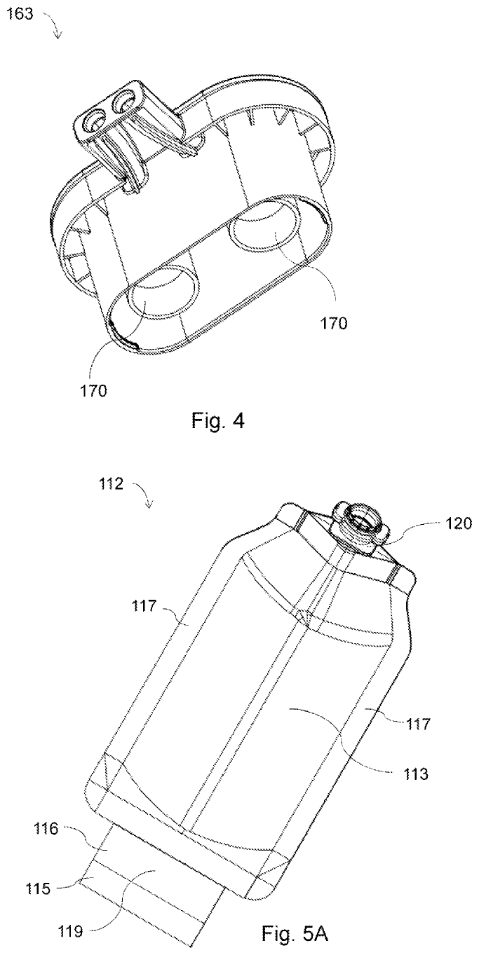

FIGS. 3A-3B are perspective views of the collar 162 viewed in different directions. FIG. 4 is a perspective view of the applicator 163. Referring to FIG. 2, FIG. 3A and FIG. 4, the airless pumps 164 are disposed in chambers formed by tubular portions 61 of the collar 162 and tubular portions 170 of the applicator 163. Inlet valves 165 and outlet valves 166 are provided at the inlets and outlets of the pumps 164, respectively. The anti-press spacer 167 can be attached to the applicator 163 between the collar 162 and the applicator 163 so as to prevent inadvertent discharge of contents from the device 10. After the anti-press spacer 167 has been removed, the applicator 163 can be pushed to move down toward the collar 162 so as to discharge fluid products.

As shown in FIG. 2 and FIG. 3B, the collar 162 comprises a base plate 60 and a pushing member 62, which extends downwards beyond the base plate 60 and into the channel 121 defined by the spout 120. In the illustrated embodiment, two pushing members 62 are provided, each corresponding to one of the two pouches 112. The pushing member 62 comprises a tubular element whose diameter is reduced in a stepwise manner, forming three consecutive cylindrical segments. The pushing member 62 further comprises a tip 621 arranged at a free end thereof, and defines four openings 623 for receiving the fluid product from the pouch 112. The tip 621 has a cross-shaped section and has tapered side surfaces 622 to facilitate engagement between the pushing member 62 and the pouch 112. The collar 162 further comprises a first recess 631 and a second recess 632 for receiving the lock member 161.

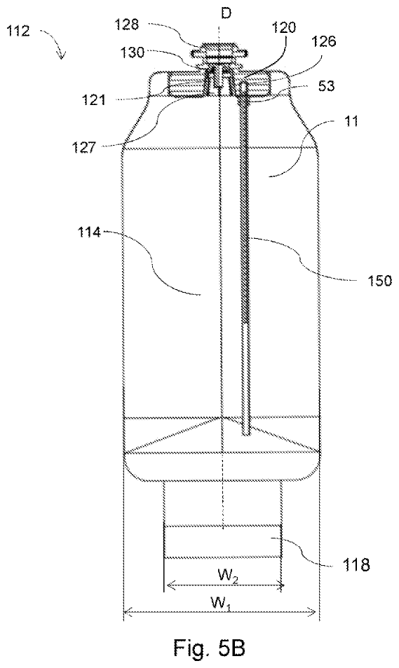

FIG. 5A is a perspective view of the pouch 112 and FIG. 5B is a sectional view of the pouch 112. As shown in FIGS. 5A-5B, the pouch 112 comprises a sachet 113 defining an inner volume in which the fluid product is contained, a spout 120 that is sealed to one end of the sachet 113 and that defines a channel 121 leading into the inner volume of the sachet 113, a closure that is embodied as a cap 130 disposed within the channel 121 of the spout 120, and a rod 150 extending from the spout 120 across the inner volume of the sachet 113. The channel 121 has an inlet end 127 (i.e., an upstream end) toward the inner volume of the sachet 113 and an outlet end 128 (i.e., a downstream end) opposite the inlet end 127. The closure, which takes the form of the cap 130, is configured to prevent air from entering the inner volume of the sachet 113 through the channel 121. The pouch 112 is shrinkable such that as the fluid product is discharged from it, the inner volume of the sachet 113 is reduced substantially in proportion to the amount of the content, i.e., the fluid product, that has been dispensed. Although the two pouches 112 have a same shape and size in the illustrated embodiment, it is also possible for them to have different shapes and sizes.

In this embodiment, the sachet 113 is formed of two flexible films 114 arranged opposite each other and joined to each other, such as by Each of the films 114 comprises a tail portion 118 hot welding. extending at one end thereof. The tail portions 118 of the two films 114 have different lengths, such that a tail of the pouch 112, which is formed by bonding the tail portions 118 of the two films 114 to each other, includes a one-film-layer portion 115 and a two-film-layer portion 116. This facilitates easy insertion of a nozzle into the sachet 113 between middle parts 119 of the tail portions 118, for air evacuation and filling of the fluid product.

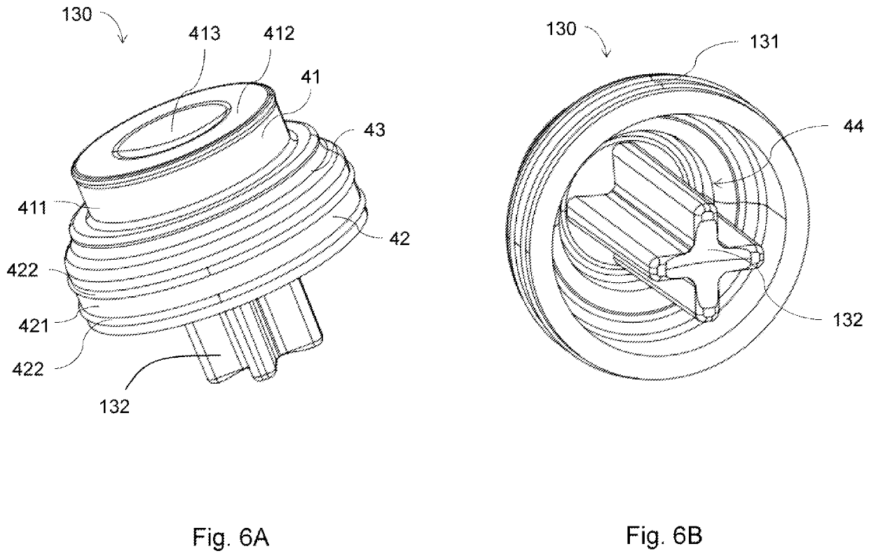

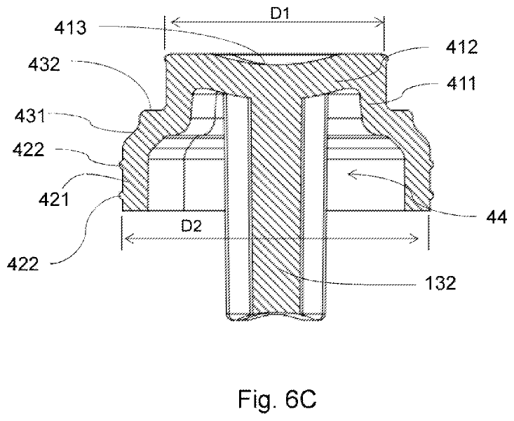

FIGS. 6A, 6B are perspective views of the cap 130 and FIG. 6C is a sectional view of the cap 130 taken along a diameter thereof. The cap 130 can be disposed within the channel 121 defined by the spout 120 so as to seal the inner volume of the sachet 113 against the environment.

As shown in FIGS. 6A-6C, the cap 130 comprises a body 131 and a holding bar 132. The body 131 comprises a first segment 41 and a second segment 42 having a larger radial dimension as compared to the first segment 41. In the embodiment as shown, the first segment 41 comprises a first cylindrical wall 411 having an outer diameter D1, and the second segment 42 comprises a second cylindrical wall 421 having an outer diameter D2 that is larger than the outer diameter D1 of the first cylindrical wall 411 of the first segment 41. The second cylindrical wall 421 is provided with an annular raised portion 422 extending around the circumference of the second cylindrical wall 421.

The first segment 41 of the body 131 of the cap 130 is configured to fit within a narrowed portion of the channel 121 defined by the spout 120. The second segment 42 of the body 131 of the cap 130 is configured to at least partially bear against a radially inner surface of the spout 120 below (i.e., upstream of) the narrowed portion of the channel 121, as explained in more detail below.

The first segment 41 further comprises a pressing plate 412 that closes the upper (i.e., downstream) end of the first segment 41, that is, the end of the first segment 41 that faces away from the inner volume of the sachet 113. Referring to FIG. 6C, the pressing plate 412 comprises a concave portion 413 at the center thereof, which facilitates engagement between the pushing members 62 of the collar 162 and the cap 130 upon unsealing of the pouch 112. Preferably, the first cylindrical wall 411 and the second cylindrical wall 421 have a same thickness, while the pressing plate 412 has a larger thickness as compared to the first and second cylindrical walls 411, 412.

The holding bar 132 of the cap 130 extends downwards from the bottom of the pressing plate 412 and has a cross-shaped section. The holding bar 132 can be easily held in hand or held by a tool or machine so that the cap 130 can be easily handled during manufacture.

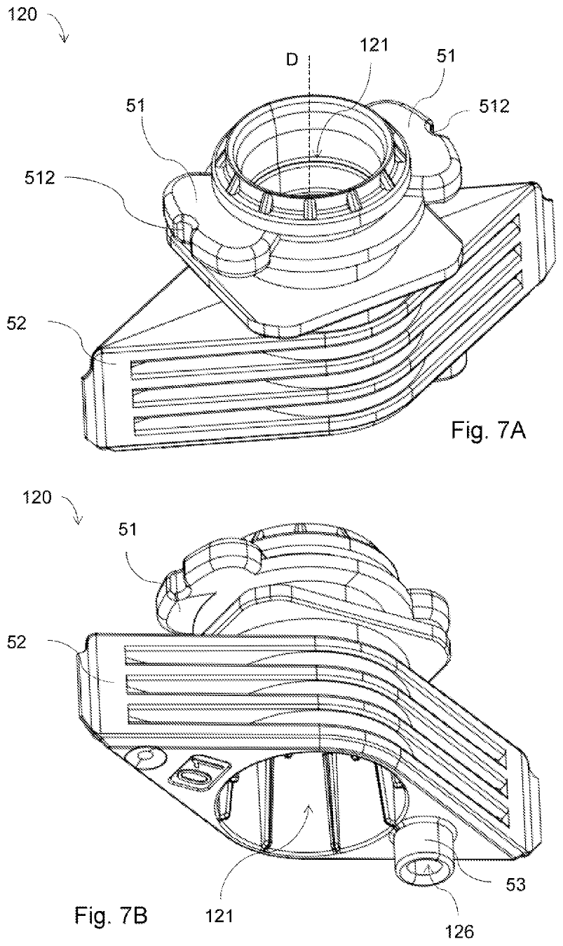

FIGS. 7A and 7B are perspective views of the spout 120. As shown in FIGS. 2 and 7A, the spout 120 defines a channel 121 extending therethrough along a longitudinal axis D of the spout 120. Lugs 51 are provided at an upper portion of the spout 120 such that the spout 120, and thus the pouch 112, can be supported on the pouch holder 140. In the illustrated embodiment, two lugs 51 are provided, although other numbers of lugs 51 are also conceivable.

The spout 120 further comprises a base 52 having curved surfaces, which are bonded to the inner surfaces of the sachet 113 in a sealing manner.

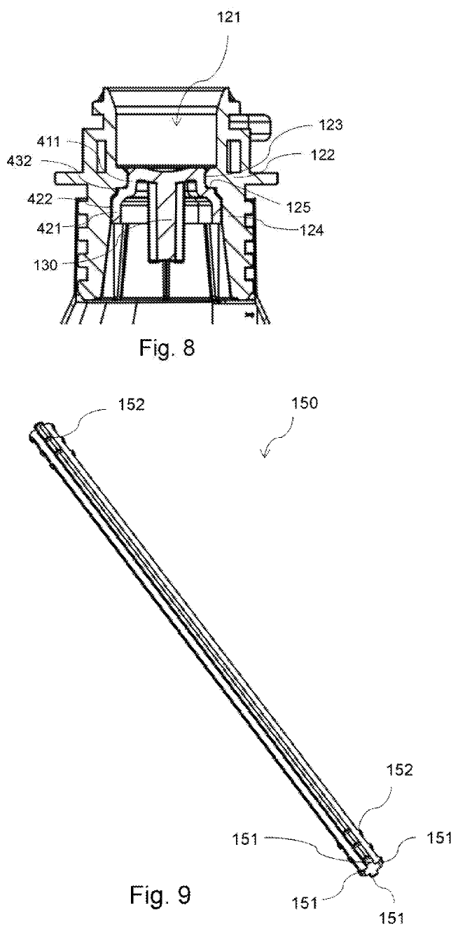

FIG. 8 is a partial enlarged sectional view of the pouch 112, showing the cap 130 fitted to the spout 120 in a sealing position. According to the present invention, the cap 130 is at least partially disposed within the channel 121 and engages the spout 120 when arranged in the sealing position. Referring to FIG. 7A and FIG. 8, the spout 120 comprises a first section 122 that is provided with a ledge. The ledge defines a circular opening and forms a narrowed portion of the channel 121.

The spout 120 further comprises a second section 124 located below the first section 122, defining a portion of the channel 121 having a circular cross-section with a relatively larger diameter. When the cap 130 is fitted to the spout 120, a radially inner surface of the second section 124 of the spout 120 is in close contact with at least a portion of the outer periphery of the second segment 42 of the body 131 of the cap 130, thereby holding the cap 130 in place and forming a hermetic seal between the spout 120 and the cap 130. In particular, the raised portions 422 of second segment 42 of the body 131 of the cap 130 bear against the radially inner surface of the second section 124 of the spout 120. Preferably, the radially outer surface of the first cylindrical wall 411 is also in close contact with a radially inner surface 123 of the first section 122 of the spout 120. For example, the first cylindrical wall 411 may abut against the first section 122 of the spout 120 along its entire circumference. This further ensures an airtight seal formed between the cap 130 and the spout 120.

In this embodiment, the cap 130 further comprises a third segment 43 that is generally tapered and that connects the lower end of the first segment 41 to the upper end of the second segment 42. As shown in FIG. 6C, the third segment 43 comprises a tapered side surface 431 and a horizontal top surface 432.

The tapered side surface 431 is generally conical and enables the cap 130 to better adapt to manufacture tolerances or spouts having different structures.

The top surface 432 extends in a radial plane and acts as a supporting surface during mounting of the cap 130 and filing of the fluid product. Referring to FIG. 8, the top surface 432 of the third segment 43 of the cap 130 bears against a lower surface 125 of the ledge of the first section 122 of the spout 120, contributing to the hermetic seal between the spout 120 and the cap 130.

The cap 130 is made of a material with an appropriate resilience such that it is slightly deformed when fitted into the spout 120. In particular, the second segment 42 of the body 131 of the cap 130 is pressed radially inwards by the second section 124 of the spout 120. The restoring force of the cap 130 ensures close contact between the cap 130 and the spout 120 over a long period of time. The cap 130 can be made of for example HDPE or PP. In the case of a highly sensitive fluid product, the cap is preferably made of POK (Polyketone), POM, NY or PET.

The manufacture of the pouch 112 will now be briefly described. A cap 130 is fitted into a spout 120 into a sealing position as shown in FIG. 8, and a rod 150 is fitted to the spout 120. Referring to FIGS. 5A-5B, two flexible films 114 are joined to each other along their edges 117 in a sealing manner, and are sealed to the base 52 of the spout 120. Each film 114 has a tail portion 118, which is located opposite the spout 120 and which has a reduced width W₂ as compared to the maximum width W₁ of the film 114. The tail portions 118 are left at least partially unsealed at this stage, such that the interior of the sachet 113 can still be accessed through a gap between the tail portions 118. For example, the left and right side edges of the tail portions 118 are sealed to each other, while the middle parts 119 of the tail portions 118 are left at least partially unsealed. As a result, the unsealed tail portions 118 provide the only fluid passage leading into the interior of the sachet 113 at this stage.

A nozzle is then introduced into the sachet 113 to withdraw air from the interior of the sachet 113. When the air inside the sachet 113 has been depleted, a fluid product is filled into the sachet 113 under a high pressure. The withdrawal of air and the filling of fluid product are preferably performed by a same, dual-purpose nozzle having an air passage and a product passage. This has the advantage that the filling of the fluid product can start immediately after finishing withdrawal of air, without any need to replace an evacuation nozzle with a filling nozzle, thereby avoiding introduction of air or contaminants during replacement of the nozzle. Advantageously, the dual-purpose nozzle may include a product passage surrounded by an annular air passage.

Upon a proper amount of filing, the nozzle is removed from the sachet 113 and the tail portions 118 of the films 114 are joined to each other, forming a sealed package having a tail. The tail helps to improve the efficiency of air evacuation and avoid entrance of air into the sachet 113 during filling of the fluid product and final sealing of the sachet 113. By evacuating air before filling the product and by high-pressure filling through the tail of the pouch 112, residual air inside the pouch 112 as produced can be minimized. Thus, air-induced deterioration of fluid product contained in the pouch 112 can be minimized, and priming numbers upon first use of the pouch 112 can be reduced.

As can be seen from FIG. 6B and FIG. 6C, the body 131 of the cap 130 defines a cavity 44. This facilitates deformation of the body 131 when the cap 130 is being fitted into the spout 120, allowing easy mounting of the cap 130. The cavity 44 also improves pressure distribution during filling of the fluid product, such that the cap 130 can be securely retained by the spout 120. Liquid product can be received in the cavity 44 during high-pressure filing of the product, exerting pressure on the inner surface of the body 131 of the cap 130 in various directions. The first and second cylindrical walls 411, 421 of the cap 130 are pressed against inner surface of the spout 120 by the high pressure, thereby the cap 130 is prevented from being tilted or loosened from the spout 120.

Since the radial dimension of the second segment 42 of the body 131 of the cap 130 is larger than the radial dimension of the first segment 41, the second segment 42 can be blocked by the ledge of the first section 122 of the spout 120 when pushed in an upward direction according to FIG. 8, preventing the cap 130 from being moved further upwards. Therefore, the cap 130 is suitable for use with high-pressure filing of the fluid product. Also, the configuration of the cap 130 according to the present invention makes it possible to provide a tamper-proof pouch 112 which, once unsealed, cannot be sealed again with a same cap 130 without destroying the sachet 113, since the cap 130 has to be mounted to the spout 120 from the inlet end 127 of the channel 121 that is located toward the inner volume of the sachet 113.

Referring to FIG. 5B and FIG. 7B, the spout 120 defines a receiving slot 126 in which one end of an elongated rod 150 is received. As shown in FIG. 9A, the rod 150 has a generally cross-shaped section with four legs 151. However, a rod with other shapes of cross-section, for example a Y-shaped cross-section with three legs, is also conceivable. Bulges 152 are provided on both ends of the rod 150 for facilitating holding the rod 150 in the receiving slot 126.

As the fluid product contained in the pouch 112 is being discharged, the inner volume of the sachet 113 decreases and the films 114 forming the sachet 113 tend to stick onto each other. Films 114 that are stuck together make it hard for the fluid products remaining at the bottom of the pouch 112 to be discharged since a fluid passage toward the channel 121 is closed. In the illustrated embodiment, with the provision of the rod 150, the films 114 are prevented from being stuck together at positions around the rod 150. The rod 150 acts as a spacer between the films 114, allowing fluid passages to be formed along the rod 150.

As shown in FIG. 7B, the receiving slot 126 is located close to the channel 121, so that the fluid product that flows through the fluid passages formed by the rod 150 can be readily delivered into the channel 121 and discharged from the pouch 112. A part of the receiving slot 126 is defined by a tubular support 53 provided on the bottom of the spout 120. The tubular support 53 facilitates positioning and retaining of the rod 150.

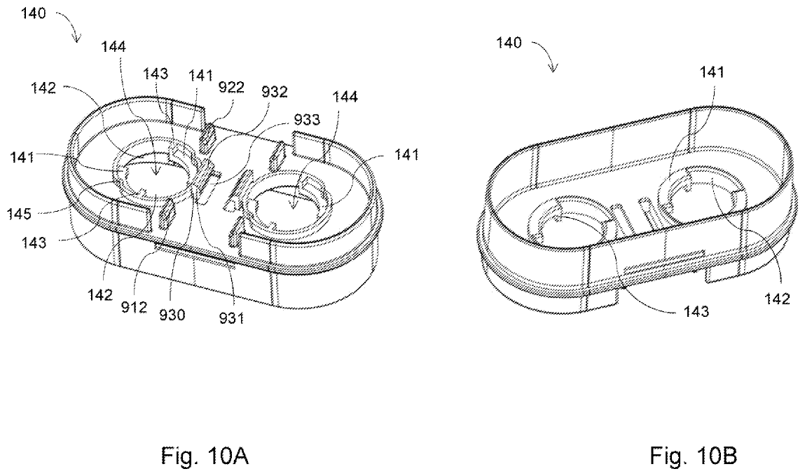

FIGS. 10A-10B are perspective views of the pouch holder 140 viewed from different directions. As can be seen, the pouch holder 140 defines two openings 144 for receiving the spouts 120 of the pouches 112. Tabs 141 are provided at the openings 144 for supporting the lugs 51 of the spout 120. In this embodiment, two tabs 141 are provided at each of the openings 144, although it is also conceivable to provide more tabs, if appropriate. The two tabs 141 are provided at diametrically opposite positions and spaced apart from each other circumferentially, leaving diametrically opposite clearances 142 therebetween. The tabs 141 are properly sized such that they can provide reliable support to the spout 120, and thus to the pouch 112, while leaving sufficient clearances 142 to allow passage of the lugs 51 therethrough. Each of the tabs 141 is further provided with an elevated edge portion 143 so as to act as a stop when the spout 120 is rotated, or to prevent inadvertent detachment of the pouch 112 from the pouch holder 140, especially during transportation of the container assembly 11. Further, each lug 51 of the spout 120 is provided with a positioning notch 512 which may be fitted to a protruding part 145 provided at the opening 144 so as to hold the spout 120 in an appropriate rotational position.

In order to support the pouch 112 on the pouch holder 140, the pouch 112 is first positioned below the pouch holder 140, with the channel 121 defined by the spout 120 aligned with one of the openings 144 defined by the pouch holder 140 and with the each of the lugs 51 of the spout 120 aligned with each of the clearances 142, respectively. The spout 120 is then inserted through the opening 144 of the pouch holder 140 such that the lugs 51 are moved past the tabs 141 through the clearances 142. After that, the spout 120 and thus the pouch 112 is rotated about the longitudinal axis D of the spout 120, such that the lugs 51 of the spout 120 become aligned with the tabs 141 of the pouch holder 140, for example being rotated until the lugs 51 of the spout 120 hits the elevated edge portions 143 of the tabs 141. The lugs 51 can then be placed on and supported by the tabs 141, thereby the pouch 112 is held in place by the pouch holder 140.

With sealed pouches 112 supported on the pouch holder 140, the pouch holder 140 can be attached to an open end of the outer container 111. The sachets 113 are thus housed inside the outer container 111, and a container assembly 11 is formed. Such a container assembly 11 can be used as a recharge pack for providing supplemental products.

As noted above, the container assembly 11 can be attached to the dispensing assembly 16 so as to form a fully-assembled device 10 as shown in FIGS. 1A-1B. The container assembly 11 can also be detached from the dispensing assembly 16 when needed as shown in FIGS. 1B-1C. For example, when one or more fluid products contained in the container assembly 11 have been depleted, the container assembly 11 can be detached from the dispensing assembly 16 and replaced with a new one.

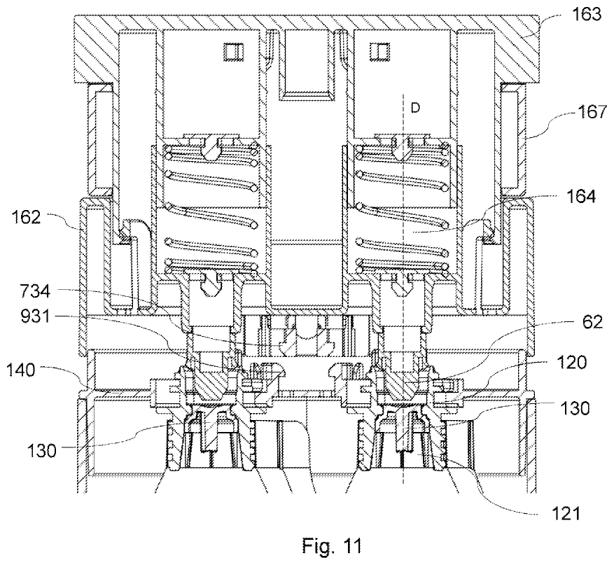

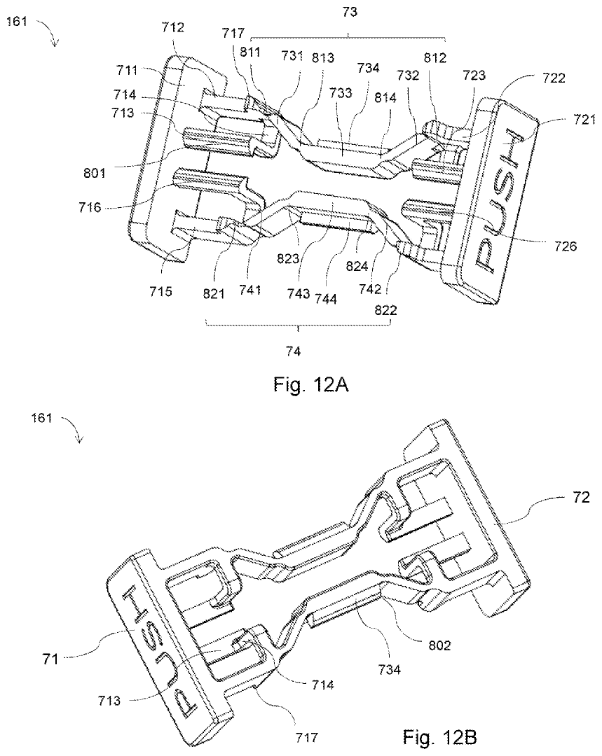

The pouches 112 of the container assembly 11 are sealed by caps 130 before being put into use. In order to attach the dispensing assembly 16 to the container assembly 11, the dispensing assembly 16 is brought to a position above the container assembly 11 and aligned therewith, as shown in FIG. 11. At this stage the device 10 is in an inactivated state. The dispensing assembly 16 is then moved downwards toward the container assembly 11 and is attached to the container assembly 11 by means of the lock member 161, as shown in FIG. 1A and FIG. 2, thereby switching the device 10 from the inactivated state into the activated state. The structure and operation of the lock member 161 will be described in detail later.

As the dispensing assembly 16 is moved downwards, the pushing members 62 of the collar 162 come into contact with the pressing plates 412 of the caps 130 and force the caps 130 out of the sealing position. Each of the caps 130 is thus disengaged from the corresponding spout 120 and drops into the inner volume of the corresponding sachet 113, thereby unsealing the corresponding pouch 112. The pushing members 62 of the collar 162 are then held in the channels 121 and engage the spout 120 in a sealing manner.

As compared to prior art devices wherein a cover of a container has to be removed before dispensing components are brought to the container, the device 10 of the present invention is advantageous in that the products inside the pouches 112 are not exposed to the environment during unsealing of the pouches 112, thereby minimizing air-induced deterioration or contamination of the product.

The lock member 161 is made of a resilient material such that it assumes a locked position when at rest. The lock member 161 can be moved into an unlocked position when acted on, for example when operated by a user, and can return to the locked position when the action thereon is eliminated. The lock member 161 is preferably made of PP, ABS, PETG, PCTA, NY, POM, POK(Polyketone), etc.

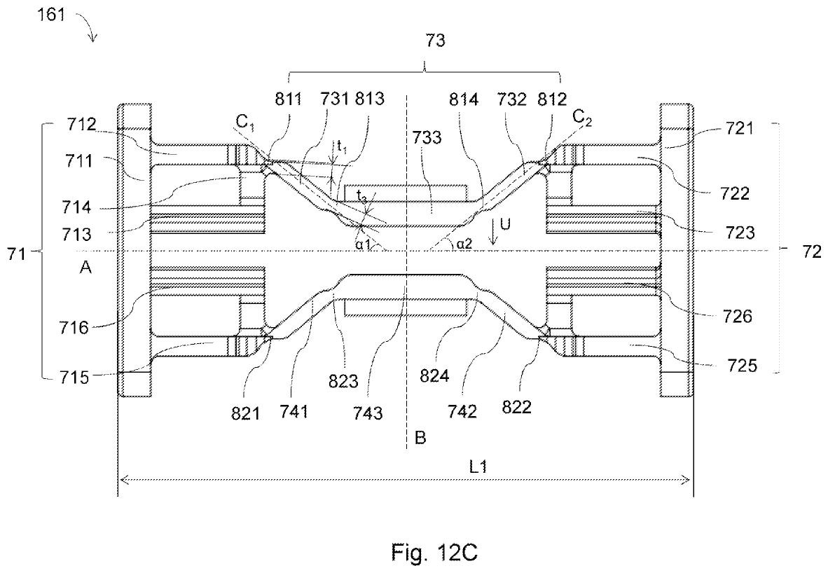

FIGS. 12A-12C show the lock member 161 in a locked position. As can be seen from FIGS. 12A-12C, the lock member 161 comprises a first end portion 71, a second end portion 72, and a first middle portion 73. The first end portion 71 comprises a first end plate 711 and a first guiding bar 712 extending from the first end plate 711. The second end portion 72 comprises a second end plate 721 and a second guiding bar 722 extending from the second end plate 721. In the illustrated embodiment, the first and second guiding bars 712, 722 extend perpendicular to the first and second end plates 711, 721, respectively. The first middle portion 73 comprises a first arm 731 connected to the first guiding bar 712 of the first end portion 71 via a first hinge 811, a second arm 732 connected to the second guiding bar 722 of the second end portion 72 via a second hinge 812, and a latch 733 extending between the first arm 731 and the second arm 732. The latch 733 is connected to the first arm 731 via a third hinge 813 on one end, and connected to the second arm 732 via a fourth hinge 814 on the other end.

Preferably, the lock member 161 is integrally formed as one piece, for example by injection molding. The hinges 811, 812, 813, 814 are each formed by a part of the lock member 161 having a reduced thickness. The first hinge 811, the second hinge 812, the third hinge 813 and the fourth hinge 814 may each have a thickness in the range of 0.3-0.85 mm, preferably 0.4-0.8 mm, more preferably 0.6-0.75 mm. In the illustrated embodiment, as shown in FIG. 12C, the first hinge 811 has a thickness t₁ of 0.7 mm, and the third hinge 813 has a thickness t₃ of 0.7 mm. Preferably, the second hinge 812 has a same thickness as the first hinge 811 and the fourth hinge 814 has a same thickness as the third hinge 813. Optionally, the four hinges 811, 812, 813, 814 have a same thickness.

The lock member 161 can be switched into the unlocked position when the first and second end plates 711, 721 are pushed to move toward each other. Referring to FIG. 12C, as the first and second end plates 711, 721 are moved toward each other, the distance L1 between the first and second end plates 711, 721 decreases and the first arm 731 is rotated in a clockwise direction. Therefore, an acute angle α1 defined between a longitudinal axis C₁ of the first arm 731 and a longitudinal axis A of the lock member 161 is increased. Similarly, the second arm 732 is rotated in a counterclockwise direction and thus an acute angle α2 defined between a longitudinal axis C₂ of the second arm 732 and the longitudinal axis A of the lock member 161 is increased. As a result, the latch 733 is displaced toward the longitudinal axis A of the lock member 161, as indicated by arrow U in FIG. 12C.

In order to allow easy and efficient displacement of the latch 733, the angle α1 and the angle α2 are in the range of 25-75 degrees, preferably between 30-60 degrees, preferably between 35-45 degrees, in particular 39 degrees. It is preferred that the angle al and the angle α2 are of a same value so as to avoid undesired distortion of the lock member 161 due to imbalance.

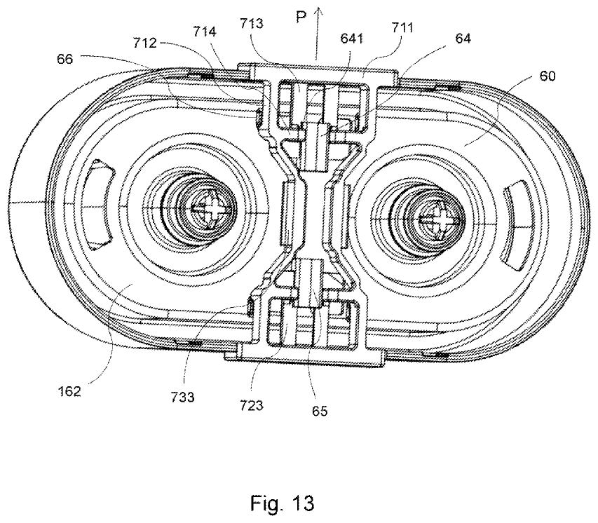

FIG. 13 shows the collar 162 with the lock member 161 disposed thereon in a locked position. As illustrated in FIG. 13, the first end portion 71 of the lock member 161 further comprises a first retaining bar 713 extending from the first end plate 711, and the collar 162 is provided with a cooperating first retaining means 64. The first retaining bar 713 is connected to the first guiding bar 712 by an L-shaped supporting bar 714, which improves the strength of the lock member 161 to avoid uncontrolled distortion. In the illustrated embodiment, the first retaining bar 713 extends parallel to the first guiding bar 712 and perpendicular to the first end plate 711.

As shown in FIG. 3B, the first retaining means 64 of the collar 162 comprises a flange 641. Referring to FIG. 13, the first retaining bar 713 of the lock member 161 is positioned between the flange 641 and the base plate 60 of the collar 162, thus attaching the lock member 161 to the collar 162. As the lock member 161 is moved between the locked position and the unlocked position, the retaining bar 713 slides in the direction of the longitudinal axis A of the lock member 161 relative to the collar 162, with at least a portion of the retaining bar 713 remain positioned between the flange 641 and the base plate 60 of the collar 162.

The first retaining means 64 of the collar 162 has a slanted lower surface 642 as shown in FIG. 3B, while the first retaining bar 713 of the lock member 161 has a slanted upper surface 801 as shown in FIG. 12A. Alternatively, the lower surface 642 of the first retaining means 64 and the upper surface 801 of the first retaining bar 713 may be curved. These slanted or curved surfaces allow easy attachment of the lock member 161 to the collar 162. By simply aligning the lock member 161 with the collar 162 and pushing it onto the collar 162, the lock member 161 can become attached to the collar 162 through snap fit between the first retaining bar 713 and the first retaining means 64. Due to the flexible nature of the lock member 161, the first retaining bar 713 is bent during this process and the upper surface 801 of the first retaining bar 713 slides across the lower surface 642 of the first retaining means 64. When the first retaining bar 713 is moved past the flange 641 of the first retaining means 64, the first retaining bar 713 returns into its original position and is thus retained between the between the flange 641 and the base plate 60 of the collar 162. The first and second end plates 711, 721 of the lock member 161 are received in the first and second recesses 631, 632 defined by the collar 162.

The base plate 60 of the collar 162 is provided with an aperture 643. The aperture is located above the flange 641 when the device 10 is arranged in an orientation according to FIGS. 1A-1C, and makes it possible for the first retaining bar 713 of the lock member 161 to bend slightly upwards through the aperture 643 under the action of the flange 641. This ensures that the first retaining bar 713 can be properly retained without putting a very tight restriction on manufacture tolerances of the first retaining bar 713 and the flange 641.

Referring to FIG. 3B and FIG. 13, the collar 162 is further provided with a boss 66. The boss 66 is located above the first guiding bar 712 when the device 10 is arranged in an orientation according to FIGS. 1A-1C and is used for stopping the lock member 161 from excess movement in the direction of the longitudinal axis A of the lock member 161. Referring to FIG. 12A, the first guiding bar 712 of the lock member 161 comprises an elevated step portion 717. When the first end portion 71 of the lock member 161 is moved into a limiting position toward the outside of the device 10 in the direction as denoted by arrow “P” in FIG. 13, the boss 66 abuts against the elevated step portion 717 of the lock member 161, thereby stopping the lock member 161 from further movement in the direction of arrow P. When the first end portion 71 of the lock member 161 is moved into a limiting position in the opposite direction, the boss 66 abuts against the first end plate 711, thereby stopping the lock member 161 from further movement.

As shown in FIG. 13, the second end portion 72 of the lock member 161 further comprises a second retaining bar 723, and the collar 162 is further provided with a second retaining means 65 for retaining the second retaining bar 723. The second retaining bar 723 and the second retaining means 65 may operate in a similar manner as the first retaining bar 713 and the first retaining means 64, and thus will not be described in further detail for the sake of brevity.

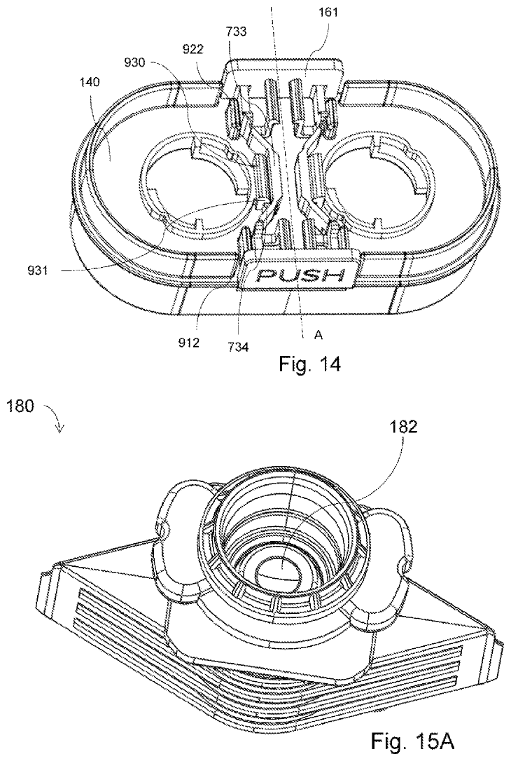

FIG. 14 shows the pouch holder 140 with the lock member 161 disposed thereon in the locked position, where the latch 733 of the lock member 161 is held by a holding means 930 of the container assembly 11, such that the dispensing assembly 16 is attached to the container assembly 11. As illustrated in FIG. 14, the holding means 930 of the pouch holder 140 comprises a flange 931 for holding the lock member 161 on the pouch holder 140. The latch 733 of the lock member 161 is provided with a locking protrusion 734, which is disposed under the flange 931 in a state as shown in FIG. 14. The upward movement of the locking protrusion 734 is thus restrained by the flange 931, preventing the lock member 161 from being removed from the pouch holder 140.

When the first and second end plates 711, 721 of the lock member 161 are pushed toward each other, the locking protrusion 734 is moved in a direction toward the longitudinal axis A of the lock member 161, such that it is no longer blocked by the flange 931. The latch 733 is thus released from the pouch holder 140 and the lock member 161 is switched into the unlocked position, such that the dispensing assembly 16 is detached from the container assembly 11.

Referring to FIGS. 10A, 12B and 14, the locking protrusion 734 of the latch 733 of the lock member 161 has a slanted lower surface 802, and the flange 931 of the holding means 930 of the pouch holder 140 has a slanted upper surface 932. Alternatively, the lower surface 802 of the locking protrusion 734 and the upper surface 932 of the flange 931 may be curved. These slanted or curved surfaces allow an easy attachment of the lock member 161, and thus the dispending assembly 16, to the pouch holder 140.

The pouch holder 140 is further provided with an aperture 933 below the flange 931, which makes it possible to properly hold the latch 733 of the lock member 161 without requiring highly demanding manufacture tolerances for the latch 733 and the flange 931.

Referring to FIGS. 10A and FIG. 14, the pouch holder 140 is further provided with a first guiding means 912 for guiding the first guiding bar 712. The first guiding means 912 is in the form of a flat wall placed on a side of the first guiding bar 712 facing away from the longitudinal axis A of the lock member 161. When the lock member 161 is moving from the locked position into the unlocked position or from the locked position into the unlocked position, the first guiding bar 712 bears against and slide along a surface of the first guiding means 912. This ensures that the first guiding bar 712 performs translational movement in the direction of the longitudinal axis A of the lock member 161, avoiding undesired tilting of the first guiding bar 712 and thereby allows an efficient unlocking process. Similarly, a second guiding means 922 is provided on the pouch holder 140 for guiding the second guiding bar 722.

In the illustrated embodiment, as shown in FIGS. 12A-12C, the first end portion 71 of the lock member 161 further comprises a third guiding bar 715 and a third retaining bar 716 extending from the first end plate 711. The second end portion 72 of the lock member 161 further comprises a fourth guiding bar 725 and a fourth retaining bar 726 extending from the second end plate 721. The lock member 161 further comprises a second middle portion 74 including a latch 743, a first arm 741, a second arm 742, a first hinge 821 connecting the third guiding bar 715 to the first arm 741, a second hinge 822 connecting the fourth guiding bar 725 to the second arm 742, a third hinge 823 connecting the first arm 741 to the latch 743 and a fourth hinge 824 connecting the second arm 742 to the latch 743. The second middle portion 74, the third and fourth guiding bars 715, 725 and the third and fourth retaining bars 716, 726 operate in a similar manner as described above and will not be explained in further detail for brevity.

As shown in FIG. 12C, according to the illustrated embodiment, the lock member 161 has a substantially symmetrical structure with respect to the longitudinal axis A thereof in the top plan view. Also, in the top plan view, the lock member 161 has a substantially symmetrical structure with respect to a central axis B that is perpendicular to the longitudinal axis A. This facilitates balanced movement and stress distribution during a locking process or an unlocking process.

The lock member 161 according to the present invention is particularly advantageous in that it allows attaching the dispensing assembly 16 to the container assembly 11 and separating the dispensing assembly 16 from the container assembly 11 with little effort. Only a simple press-on operation with low pressing force is required for an attachment, and only a simple push-and-lift operation with low pushing force is required for a detachment. The lock member 161 according to the present invention also ensures reliable attachment between the dispensing assembly 16 and the container assembly 11 with little risk of undesired accidental detachment.

The device 10 may be stored in the inactivated state with the pouches 112 of the container assembly 11 remain sealed until its first use. In order to activate the device 10, a user presses the dispensing assembly 16 onto the container assembly 11, such that the dispensing assembly 16 is attached to the container assembly 11 and at the same time the caps 130 are displaced from the sealing position to unseal the pouches 112. The user can detach the dispending assembly 16 from the container assembly 11 by pushing the end plates 711, 712 of the lock member 161 and lifting the dispensing assembly 16. As such, the container assembly 11 can be replaced and the dispending assembly 16 can be reused. The device 10 according to the present invention allows easy replacement of the container assembly 11 with minimized exposure of the fluid products to the air, which is a significant advantage over the prior art.

Although in the illustrated embodiment, the cap 130 is described as having cylindrical segments with generally circular cross-sections, it is also conceivable for the cap 130 to include segments with other cross-sectional shapes. For example, the cap 130 may have a rectangular cross-section. However, the circular cross-sectional shape as described is particularly advantageous in that it contributes to a uniform close contact between the cap 130 and the spout 120 around the entire circumference. Also, the cap 130 as described does not have to be rotated into a certain rotational position to fit in the channel 121, enabling more efficient manufacture of the pouch 121.

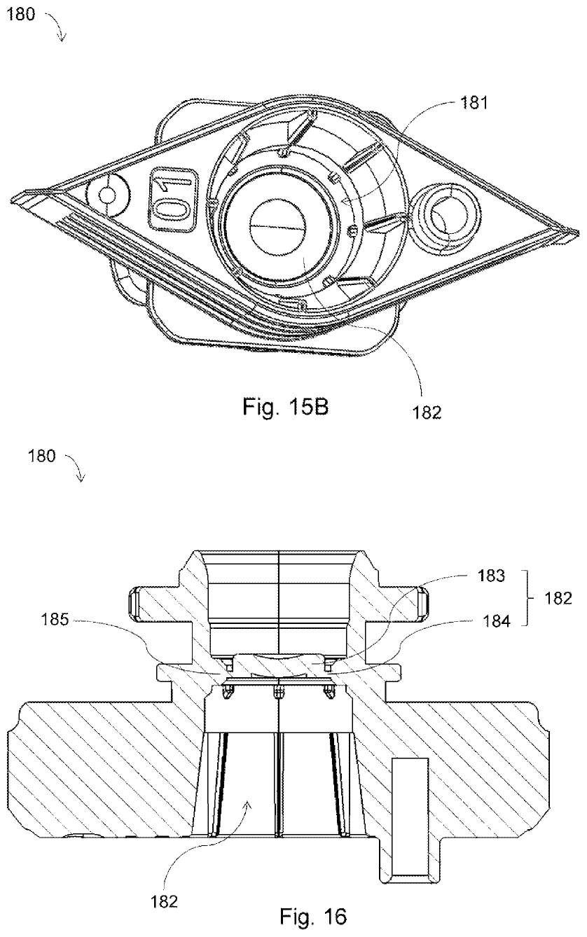

FIG. 15A and FIG. 15B are perspective views of a spout 180, which is an alternative variant that can be used in place of the above-described spout 120. In this variant, the closure that closes the channel 181 defined by the spout 180 is in the form of a breakable portion 182 of the spout 180, instead of in the form of a cap. As shown in FIG. 16, which is a sectional view of the spout 180, the breakable portion of the spout 180 comprises a body, which comprises a first segment 183 and a second segment 184 having a larger outer diameter than the first segment 183. The breakable portion 182 is integrally formed with the other portions of the spout 180. In this variant, the spout comprises a ledge 185 that defines a narrowed section of the channel 181. The second segment 184 of the body of the breakable portion is directly connected to the ledge along its radially outer periphery, providing an airtight sealing.

When pushed by a pushing member 62, the breakable portion can be at least partially torn off from the other portions of the spout 180, so as to unseal the pouch 112. Preferably, the second segment 184 has a smaller longitudinal thickness than the first segment 183, as illustrated in FIG. 16. This makes it easier to break the breakable portion 182 and provide a proper opening to accommodate the pushing member 62. Typically, the breakable portion 182 will be broken at the second segment 184, due to the reduced longitudinal thickness thereof.

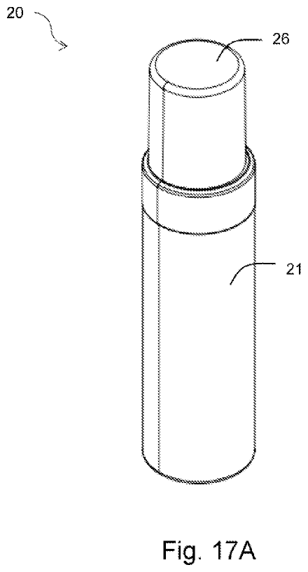

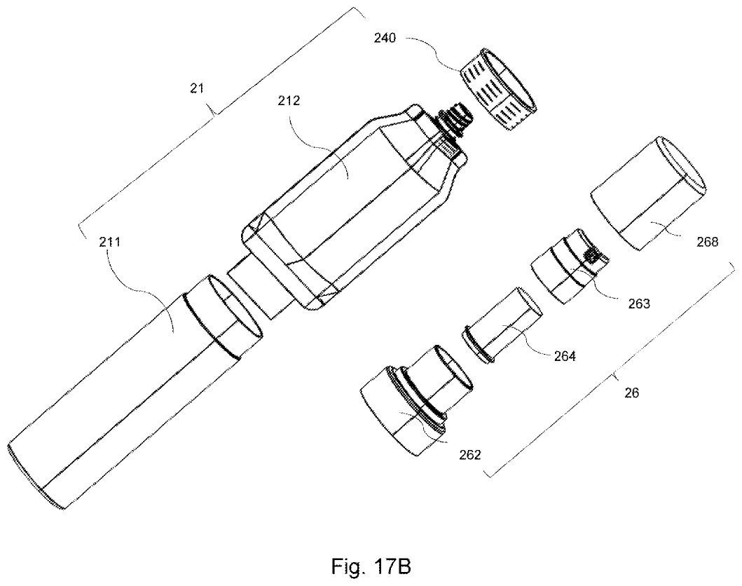

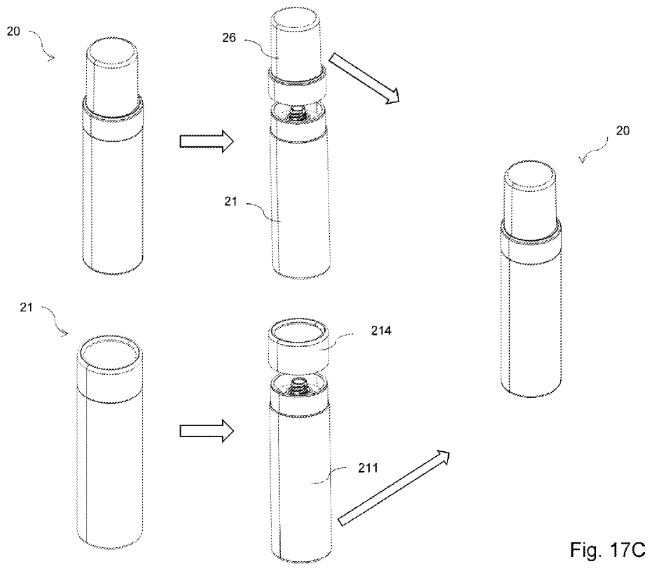

FIG. 17A is a schematic perspective view of a second embodiment of a device 20 for storing and dispensing at least one fluid product according to the present invention, in a fully-assembled or activated state. FIG. 17B is a schematic exploded view of the device 20.

As shown in FIGS. 17A-17B, the device 20 comprises a container assembly 21 including an outer container 211, a pouch 212 and a pouch holder 240. The device 20 further comprises a dispensing assembly 26 that can be mounted onto the container assembly 21, comprising a collar 262, an applicator 263, an airless pump 264 and a cover 268.

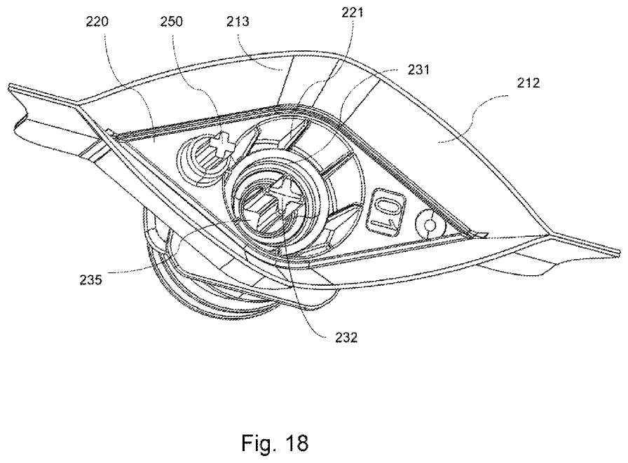

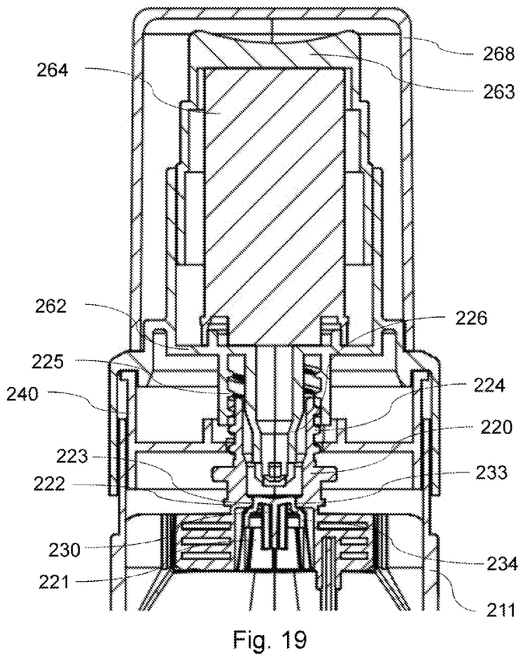

FIG. 18 is a cut-away view of the pouch 212. FIG. 19 is a partial enlarged sectional view showing the device 20 in an inactivated state.

As illustrated in FIGS. 18 and 19, the pouch 212 comprises a sachet 213, a spout 220, a closure that is embodied as a cap 230, and a rod 250. The spout 220 defines a channel 221 that leads into the inner volume of the sachet 213. The cap 230 comprises a body 231 and a holding bar 232. The body 231 of the cap 230 comprises a first segment 233 that is configured to fit within a narrowed section of a channel 221, and a second segment 234 having a larger radial dimension as compared to the first segment 233 and configured to be supported by the spout 220 at a position below the narrowed section of the channel 221. The first segment 233 of the body 231 of the cap 230 further comprises a pressing plate 235 closing the upper end of the cap 230.

Referring to FIG. 19, the spout 220 comprises a first section 222 having a ledge that defines the narrowed section of the channel The cap 230 can be mounted onto the spout 220 through 221. interference fit between the first segment 233 of the body 231 of the cap 230 and the ledge of the spout 220. The radially outer surface of the first segment 233 of the body 231 of the cap 230 can be arranged in close contact with the radially inner surface 223 of the ledge of the spout 220 over the entire circumference, such that the cap 230 seals the inner volume of the sachet 213 against the environment.

In this embodiment, as shown in FIG. 18, ribs 221 are provided at the radially inner surface of the spout 220. These ribs press the second segment 234 of the body 231 of the cap 230 in a radial direction and contribute to holding the cap 230 in place. Each of the ribs 221 is wedge-shaped, which facilitates insertion and proper orientation of the cap 230.

In this embodiment, the spout 220 is provided with an outer thread 224, as shown in FIG. 19. The collar 262 comprises a tubular portion extending downwards and provided with an inner thread 225 for mating with the outer thread 224 of the spout 220. The collar 262 further comprises a pushing member 226 that extends into the channel 221 defined by the spout 220.

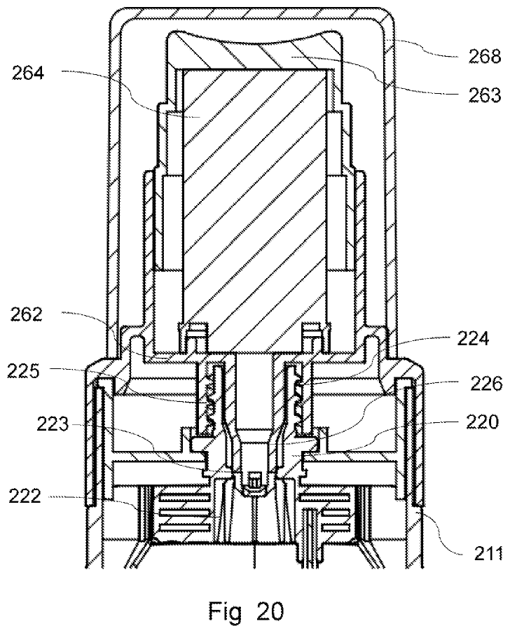

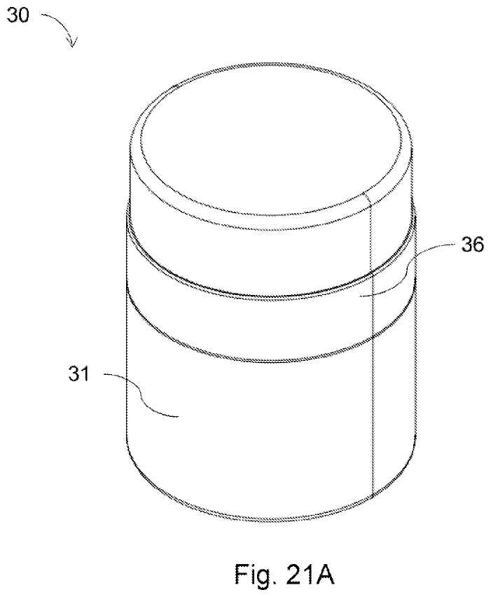

In order to switch the device 20 into an activated state as shown in FIG. 20, a user may rotate the collar 262 relative to the spout 220 such that the collar 262 moves downwards toward the container assembly 21 due to the cooperating outer and inner threads 224, 225. The pushing member 226 presses on the pressing plate 235 of the cap 230. As a result, the cap 230 is fully separated from the spout 220 and drops into the inner volume of the sachet 213, thereby unsealing the pouch 212. Fluid product contained in the pouch 212 can then be discharged from the device 20.

When the fluid product contained in the pouch 212 has been depleted, the dispensing assembly 26 can be removed from the used-up container assembly 21 by releasing the threaded connection between the collar 262 and the spout 220. The dispensing assembly 26 can then be attached to a replacement container assembly 21 for reuse. FIG. 17C schematically shows the procedure of replacing an emptied container assembly 21 forming a part of the device 20 with a replacement container assembly 21. The replacement container assembly 21 may optionally comprise a container cover 214 capped on the pouch holder 240 thereof as a shield against the environment, thereby avoiding accidental unsealing of the pouch 212. The container cover 214 is removed to put the replacement container assembly 21 into use.

As an alternative, it is also conceivable that the collar and the spout are connected to each other by interference fit, for example by bayonet connection. In this case, a user can attach the dispensing assembly or detach the dispensing assembly from the container assembly by a simple pressing or lifting operation.

The outer container 211 can be made of e.g. paper, glass, plastic and/or metal, for example aluminum. Paper and glass outer containers are particularly advantageous in that the container assembly 21 can be made light-weight, environmental-friendly and with low cost.

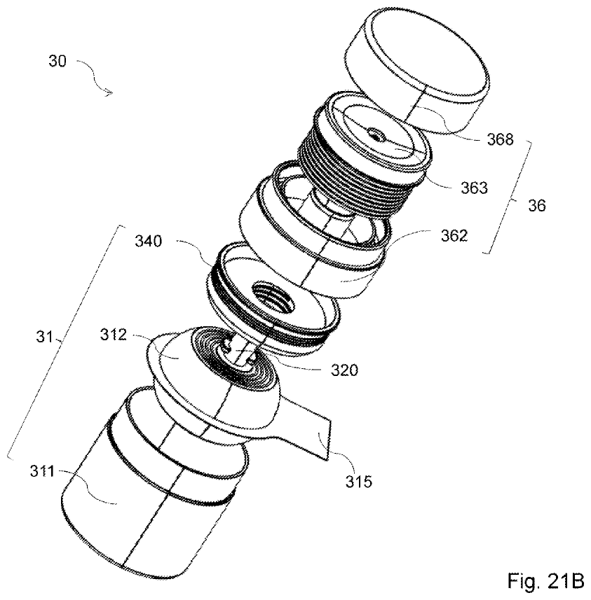

FIG. 21A is a schematic perspective view of a third embodiment of a device 30 for storing and dispensing at least one fluid product according to the present invention, in a fully-assembled or activated state. FIG. 21B is a schematic exploded view of the device 30.

As shown in FIGS. 21A-21B, the device 30 comprises a container assembly 31 including an outer container 311, a pouch 312 and a pouch holder 340. The device 30 further comprises a dispensing assembly 36 that can be mounted onto the container assembly 31, comprising a collar 362, an applicator 363, and a cover 368.

It is understood that although the closure is in the form of a cap 230 in the illustrated embodiment, it is also possible to use a spout having an integrally formed breakable portion as a closure.

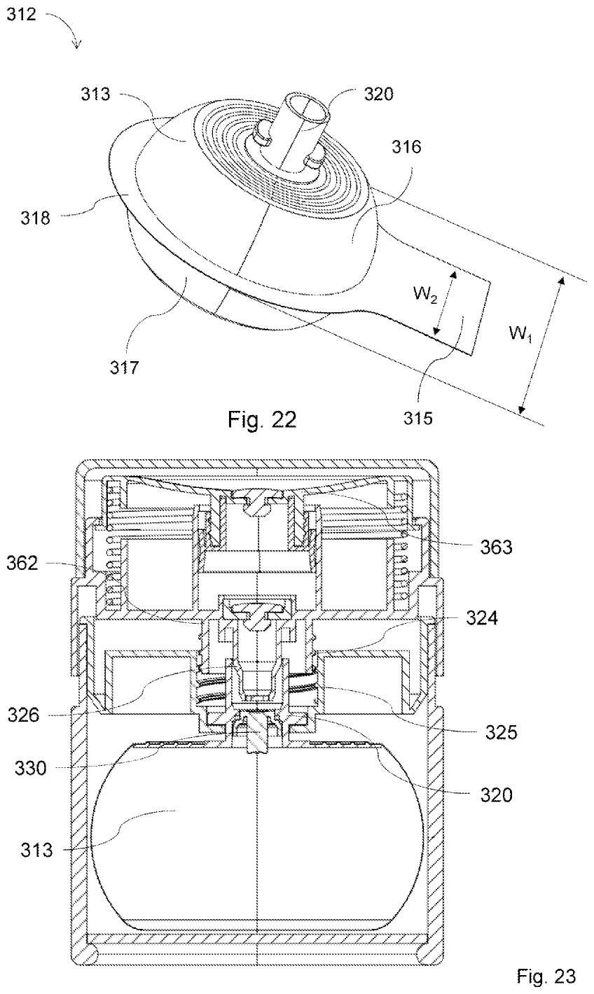

In this embodiment, as shown in FIGS. 22-23, the pouch 312 comprises a sachet 313 made of an upper film 316 and a lower film 317, a spout 320 bonded to an upper surface of the upper film 316, and a cap 330. The upper and lower films 316, 317 are jointed to each other along their circumferential peripheries, forming a generally circular or arcuate circumferential edge 318. Each of the upper film 316 and the lower film 317 comprises a tail portion that are joined together to form a tail 315 of the pouch 312. During manufacture of the pouch 312, a nozzle for evacuation of air and high-pressure filling of a fluid product can be inserted through the tail 315, which has not yet been sealed, into the interior of the sachet 313. The tail 315 makes it possible to minimize residual air in the sealed pouch 312.

The tail portions of the upper and lower films 316, 317 are bonded to each other after air evacuation from the interior of the sachet 313 and high-pressure filling of a fluid product into the sachet 313, similar to the procedure as described above for the first embodiment.

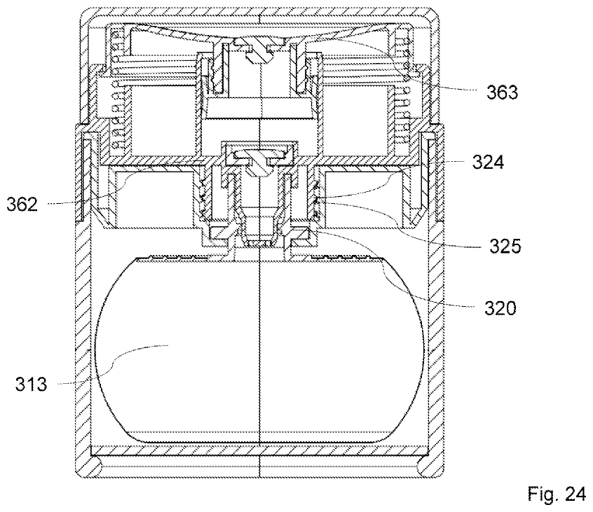

FIG. 23 shows a sectional view of the device 30 in an inactivated state. FIG. 24 shows a sectional view of the device 30 in the activated state. In this embodiment, the collar 362 comprises a tubular portion extending downwards and provided with an outer thread 324, and the pouch holder 340 comprises a tubular portion provided with an inner thread 325. In order to switch the device 30 from the inactivated state into the activated state, the collar 362 is rotated and thus moved downwards toward the cap 330. The pushing member 326 is fixed to the bottom of the collar 362 and presses on the cap 330 so that the cap 330 is displaced away from the spout 320.

The dispensing assembly 36 can be detached from a used-up container assembly 31 by releasing the threaded connection between the collar 362 and the pouch holder 340. A replacement container assembly 31 can be attached to the dispensing assembly 36. The outer container 311 can be made of various materials, for example plastic, paper or glass. However, it is preferred that the outer container 311 is made of paper for the reasons as explained above.

Although the present invention has been described in terms of exemplary embodiments, it not limited thereto. The detailed description is to be construed as exemplary only and does not describe every possible embodiment of the present disclosure. Numerous alternative embodiments could be implemented, using either current technology or technology developed after the filing date of this patent that would still fall within the scope of the claims defining the invention(s) disclosed herein.

Those skilled in the art will recognize that a wide variety of modifications, alterations, and combinations can be made with respect to the above-described embodiments without departing from the spirit and scope of the invention(s) disclosed herein, and that such modifications, alterations, and combinations are to be viewed as being within the ambit of the inventive concept(s).

### LIST OF REFERENCE NUMERALS

10 device for storing and dispensing at least one fluid product

### First Embodiment

11 container assembly
111 outer container
112 pouch
113 sachet
114 film
115 one-film-layer portion of the tail of the pouch
116 two-film-layer portion of the tail of the pouch
117 edge of the film
118 tail portion of the film
119 middle part of the tail portion
120 spout
121 channel
122 first section of the spout
123 radially inner surface of the first section
124 second section of the spout
125 lower surface of the ledge
126 receiving slot
127 inlet end of the channel
128 outlet end of the channel
130 cap
131 body of the cap
132 holding bar of the cap
140 pouch holder
141 tab
142 clearance
143 elevated edge portion
144 opening of pouch holder
145 protruding part
150 rod
151 leg of the rod
152 bulges
16 dispensing assembly
161 lock member
162 collar
163 applicator
164 airless pump
165 inlet valve
166 outlet valve
167 anti-press spacer
170 tubular portion of the applicator
180 spout
181 channel
182 breakable portion
183 first segment of the body of the breakable portion
184 second segment of the body of the breakable portion
185 ledge
41 first segment of the body
411 first cylindrical wall
412 pressing plate
413 concave portion
42 second segment of the body
421 second cylindrical wall
422 raised portion
43 third segment of the cap
431 side surface of the third segment
432 top surface of the cap
44 cavity
51 lug
52 base
512 positioning notch
53 tubular support
60 base plate
61 tubular portion of the collar
62 pushing member
621 tip of the pushing member
622 tapered side surface of the tip
623 opening of the pushing member
631 first recess
632 second recess
64 first retaining means
641 flange of the first retaining means
642 lower surface of the first retaining means
643 aperture
65 second retaining means
66 boss
71 first end portion of the lock member
711 first end plate
712 first guiding bar
713 first retaining bar
714 L-shaped supporting bar
715 third guiding bar
716 third retaining bar
717 elevated step portion
72 second end portion of the lock member
721 second end plate
722 second guiding bar
723 second retaining bar
725 fourth guiding bar
726 fourth retaining bar
73 first middle portion
731 first arm of the first middle portion
732 second arm of the first middle portion
733 latch of the first middle portion
734 locking protrusion of the first middle portion
74 second middle portion
741 first arm of the second middle portion
742 second arm of the second middle portion
743 latch of the second middle portion
744 locking protrusion of the second middle portion
801 upper surface of the first retaining bar
802 lower surface of the latch of the first middle portion
811 first hinge of the first middle portion
812 second hinge of the first middle portion
813 third hinge of the first middle portion
814 fourth hinge of the first middle portion
821 first hinge of the second middle portion
822 second hinge of the second middle portion
823 third hinge of the second middle portion
824 fourth hinge of the second middle portion
912 first guiding means
922 second guiding means
930 holding means
931 flange of the holding means
932 upper surface of the holding means
933 aperture of the pouch holder
20 device for storing and dispensing at least one fluid product

### Second Embodiment

21 container assembly
211 outer container
212 pouch
213 sachet
214 container cover
220 spout
221 channel
222 first section of the spout
223 radially inner surface of the ledge
224 outer thread
225 inner thread
226 pushing member
230 cap
231 body of the cap
232 holding bar of the cap
233 first segment of the body
234 second segment of the body
235 pressing plate of the cap
240 pouch holder
26 dispensing assembly
262 collar
263 applicator
264 airless pump
268 cover
30 device for storing and dispensing at least one fluid product

### Third Embodiment

31 container assembly
311 outer container
312 pouch
313 sachet
315 tail
316 upper film
317 lower film
318 circumferential edge of the sachet
320 spout
324 outer thread
325 inner thread
326 pushing member
330 cap
340 pouch holder
36 dispensing assembly
362 collar
363 applicator
368 cover

1. A pouch for storing a fluid product, comprising:
a sachet defining an inner volume in which the fluid product is contained;
a spout attached to the sachet in a sealing manner and defining a channel leading into the inner volume of the sachet,
the channel having an inlet end toward the inner volume of the sachet and an outlet end opposite the inlet end;
a closure comprising a body having a first segment with a first radial dimension and a second segment with a second radial dimension larger than the first radial dimension, wherein the second segment is located on a side of the first segment toward the inner volume of the sachet;
wherein the closure is configured to prevent air from entering the inner volume of the sachet through the channel in a sealing position, wherein the closure is at least partially disposed in the channel and engages the spout when arranged in the sealing position; and
wherein the closure can be displaced away from the sealing position when pushed by a pushing member toward the inner volume of the sachet to unseal the pouch.

2. The pouch according to claim 1, wherein the closure is integrally formed with the spout, wherein the second segment preferably has a smaller longitudinal thickness than the first segment.

3. The pouch according to claim 1, wherein the closure comprises a cap, wherein the cap is separated from the spout when displaced away from the sealing position, wherein the first segment of the body of the cap comprises a first cylindrical wall and a pressing plate, and wherein the second segment of the body of the cap comprises a second cylindrical wall having a larger outer diameter than the first cylindrical wall.

4. The pouch according to claim 3, wherein the cap further comprises a holding bar extending from the pressing plate toward the inner volume of the sachet,the holding bar preferably having a cross-section that is cross-shaped.

5. The pouch according to claim 3, wherein the body of the cap-defines a cavity located toward the inner volume of the sachet.

6. The pouch according to claim 3, wherein the body of the cap further comprises a tapered third segment between the first segment and the second segment, wherein the third segment has a supporting surface extending in a radial plane and a side surface having a conical shape.

7. The pouch according to claim 3, wherein the second segment of the body of the cap is provided with raised portions, for abutting against the spout

8. The pouch according to claim 1, wherein the pouch further comprises a rod having a cross-shaped section, the rod extending from the spout into the inner volume of the sachet.

9. The pouch according to claim 1, wherein the sachet is formed of two films joined to each other along their peripheries, wherein each of the films comprises a tail portion having a reduced width, wherein the tail portions of the two films are joined together to form a tail of the pouch.

10. A container assembly for storing at least one fluid product, comprising:
an outer container;
at least one pouch according to claim 1 disposed in the outer container; and
a pouch holder for holding the pouch, the pouch holder being attached to the outer container.

11. A device for storing and dispensing at least one fluid product, comprising:
a container assembly according to claim 10;
a dispensing assembly that can be attached to the container assembly and that can be detached from the container assembly;
wherein the dispensing assembly comprises a pushing member, which pushes the closure such that the closure is displaced away from the sealing position when the dispensing assembly is moved toward the container assembly so as to be attached to the container assembly.

12. The device according to claim 11, wherein the dispending assembly comprises an applicator, an airless pump and a collar that is provided with the pushing member, wherein the airless pump is arranged between the applicator and the collar, wherein the pushing member comprises a tip having a cross-shaped section and tapered side surfaces.

13. The device according to claim 11, wherein the dispensing assembly can be attached to the container assembly by connecting the collar to the spout of the pouch or to the pouch holder through a threaded connection or through an interference fit.

14. The device according to claim 11, wherein the dispensing assembly is provided with a lock member, the lock member comprising a first end portion, a second end portion and a first middle portion between the first end portion and the second end portion, wherein the first middle portion comprises a first arm connected to the first end portion via a first hinge, a second arm connected to the second end portion via a second hinge, and a latch connected on one end to the first arm via a third hinge, and connected on the other end to the second arm via a fourth hinge, wherein the lock member can be moved between a locked position and an unlocked position;
wherein the container assembly, is provided with a holding means;
wherein in the locked position, the latch of the lock member is held by the holding means of the container assembly, such that the dispensing assembly is attached to the container assembly; and
wherein in the unlocked position, the latch of the lock member is released from the holding means of the container assembly, such that the dispensing assembly is detached from the container assembly.

15. The device according to claim 14, wherein the first end portion of the lock member comprises a first end plate, a first guiding bar and a first retaining bar, and the second end portion of the lock member comprises a second end plate, a second guiding bar and a second retaining bar;
wherein the first guiding bar is connected to the first arm of the first middle portion via the first hinge, wherein the second guiding bar is connected to the second arm of the first middle portion via the second hinge;
wherein the collar is provided with a first retaining means for retaining the first retaining bar, and a second retaining means for retaining the second retaining bar.

16. The device according to claim 14, wherein an acute angle in the range of 25-75 degrees, is defined between a longitudinal axis of the first arm and a longitudinal axis of the lock member, and between the longitudinal axis of the second arm and the longitudinal axis of the lock member.

17. The device according to claim 14, wherein the first guiding bar is connected to the first retaining bar by an L-shaped supporting bar.

18. The device according to claim 14, wherein the lock member further comprises a second middle portion between the first end portion and the second end portion, wherein the second middle portion comprises a first arm connected to the first end portion via a first hinge, a second arm connected to the second end portion via a second hinge, and a latch connected on one end to the first armvia a third hinge, and connected on the other end to the second arm via a fourth hinge; wherein preferably, the first arm of the second middle portion is connected to a third guiding bar of the first end portion of the lock member, and the second arm of the second middle portion-is connected to a fourth guiding bar of the second end portion of the lock member.
